(19) United States
(12) Patent Application Publication
(10) Pub. No.: US 2016/0216555 A1
(43) Pub. Date: Jul. 28, 2016

(54) LIQUID CRYSTAL DISPLAY

(71) Applicant: SAMSUNG DISPLAY CO., LTD., Yongin-si (KR)

(72) Inventors: Hee Ra KIM, Seoul (KR); Chang-Soon JANG, Seoul (KR); Yi Seop SHIM, Suwon-si (KR); Sun-Young CHANG, Bucheon-si (KR)

(21) Appl. No.: 15/009,471

(22) Filed: Jan. 28, 2016

(30) Foreign Application Priority Data
Jan. 28, 2015 (KR) 10-2015-0013777

(51) Int. Cl. G02F 1/1335; G02F 1/1368

(52) U.S. Cl. CPC G02F 1/133514; G02F 1/1368; G02F 1/133512

(57) ABSTRACT

A liquid crystal display includes a first substrate and a second substrate. A plurality of thin film transistors and a plurality of pixel electrodes connected thereto are formed on the first substrate. The second substrate faces the first substrate and includes a color filter. The color filter includes a blue color filter, a green color filter, and a red color filter corresponding to each pixel electrode. A yellow color filter is formed on at least one of the green color filter and the red color filter.

### CROSS-REFERENCE TO RELATED APPLICATION

This application claims priority to and the benefit of Korean Patent Application No. 10-2015-0013777 filed in the Korean Intellectual Property Office on Jan. 28, 2015, the entire contents of which are incorporated herein by reference.

### BACKGROUND

(a) Technical Field

The present disclosure generally relates to a liquid crystal display.

(b) Description of the Related Art

A liquid crystal display is a type of flat panel display that is widely used. A liquid crystal display typically includes two sheets of display panels on which field generating electrodes (such as a pixel electrode and a common electrode) are formed and a liquid crystal layer interposed therebetween. A voltage is applied to the field generating electrodes to generate an electric field over the liquid crystal layer. The electric field determines an orientation of liquid crystal molecules of the liquid crystal layer and controls polarization of incident light passing through the liquid crystal layer, thereby enabling an image to be displayed on the liquid crystal display.

A color filter is formed on one side of the display panels, and light passing through the liquid crystal layer passes through the color filter to display different colors. An image can be displayed by a combination of the different colors. The colors of the image should be rich and clear. Accordingly, it is important to control the color of the color filter.

The above information disclosed in this Background section is only to enhance understanding of the background of the inventive concept and therefore it may contain information that does not form the prior art that is already known in this country to a person of ordinary skill in the art.

### SUMMARY

The present disclosure discloses a liquid crystal display having improved color reproducibility.

According to an exemplary embodiment of the inventive concept, a liquid crystal display is provided. The liquid crystal display includes: a first substrate, wherein a plurality of thin film transistors and a plurality of pixel electrodes connected thereto are formed on the first substrate; and a second substrate facing the first substrate and including a color filter, wherein the color filter includes a blue color filter, a green color filter, and a red color filter corresponding to each pixel electrode, and a yellow color filter is formed on at least one of the green color filter and the red color filter.

In some embodiments, a thickness of the green color filter may range from about 1 μm to about 2 μm.

In some embodiments, a thickness of the red color filter may range from about 1 μm to about 2 μm.

In some embodiments, the yellow color filter may be formed on the green color filter, and a ratio of a thickness of the green color filter to a thickness of the yellow color filter may be between about 99:1 to about 50:50.

In some embodiments, the yellow color filter may be formed on the red color filter, and a ratio of a thickness of the red color filter to a thickness of the yellow color filter may be between about 99:1 to about 70:30.

In some embodiments, a thickness of the yellow color filter may range from about 0.1 μm to about 1 μm.

In some embodiments, the color filter may further include a white color filter corresponding to each pixel electrode.

In some embodiments, the yellow color filter may be formed on the white color filter.

In some embodiments, the color filter may further include a white color filter and a yellow color filter corresponding to each pixel electrode.

In some embodiments, a yellow pigment may be omitted from the green color filter.

In some embodiments, a yellow pigment may be omitted from the red color filter.

In some embodiments, a common electrode may be formed on the second substrate.

In some embodiments, a black matrix may be formed between the blue color filter, the green color filter, and the red color filter.

### BRIEF DESCRIPTION OF THE DRAWINGS

FIG. 1 is a cross-sectional view of an upper substrate and a color filter of a liquid crystal display according to an exemplary embodiment.

FIG. 2 is a cross-sectional view of an upper substrate and a color filter of a liquid crystal display according to a comparative example.

FIG. 3 is a diagram illustrating a shift in color coordinates between the liquid crystal display according to the exemplary embodiment of FIG. 1 and the liquid crystal display according to the comparative example of FIG. 2.

FIG. 4 is a table containing values of the color coordinate shift in FIG. 3.

FIG. 5 is a cross-sectional view of a liquid crystal display according to another exemplary embodiment.

FIG. 6 is a layout view of a liquid crystal display according to an exemplary embodiment.

FIG. 7 is a cross-sectional view of the liquid crystal display of FIG. 6 taken along line II-II.

### DETAILED DESCRIPTION

The inventive concept will be described more fully herein with reference to the accompanying drawings, in which exemplary embodiments are shown. As those skilled in the art would realize, the embodiments may be modified in various ways without departing from the spirit or scope of the present disclosure.

In the drawings, the thicknesses of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element, or with one or more intervening elements being present. In contrast, when an element is referred to as being “directly on” another element, there are no intervening elements present.

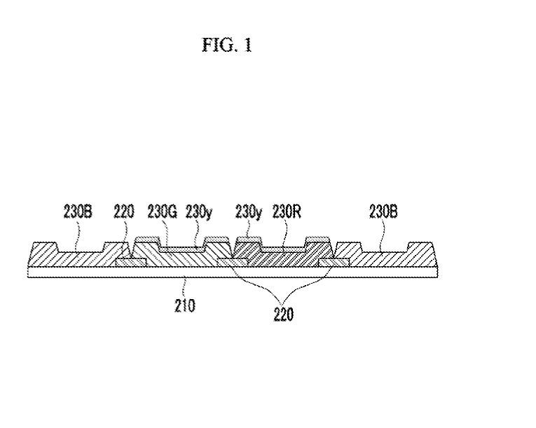

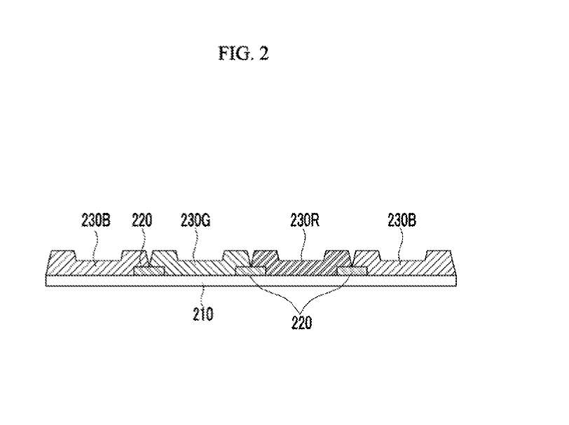

FIG. 1 is a cross-sectional view of an upper substrate 210 and a color filter 230 of a liquid crystal display according to an exemplary embodiment. FIG. 2 is a cross-sectional view of an upper substrate 210 and a color filter 230′ of a liquid crystal display according to a comparative example.

The liquid crystal display in each of FIGS. 1 and 2 includes a lower substrate on which at least one thin film transistor is formed, an upper substrate on which the color filter is formed, and a liquid crystal layer interposed therebetween. Liquid crystal molecules in the liquid crystal layer are aligned by an electric field formed between a pixel electrode and a common electrode. The pixel electrode and the common electrode may be positioned on the lower substrate or the upper substrate. Light passing through the aligned liquid crystal layer displays a color after passing through the color filter.

Referring to FIG. 1, the liquid crystal display according to the exemplary embodiment includes the upper substrate 210, black matrixes 220 formed on the upper substrate 210, and the color filter 230 formed between the black matrixes 220. Although not illustrated, a thin film transistor and a pixel electrode connected thereto may be disposed in a region between adjacent black matrixes 220, and collectively constitute a pixel.

The color filter 230 is formed in each pixel. For example, a blue color filter 230B is formed in a first pixel, a green color filter 230G is formed in a second pixel, and a red color filter 230R is formed in a third pixel. The blue, green and red color filters 230B, 230G, and 230R are formed adjacent to each other. As shown in FIG. 1, a yellow color filter 230y is formed on the green color filter 230G and the red color filter 230R.

A thickness of each of the green color filter 230G and the red color filter 230R may range from about 1 μm to about 2 μm. In the embodiment of FIG. 1, the yellow color filter 230y is not formed on the blue color filter 230B. Accordingly, the blue color filter 230B may have a greater thickness than the green color filter 230G and/or the red color filter 230R.

A thickness of the color filter 230 may be changed depending on the color that is to be displayed. For example, in some embodiments, a thickness of the yellow color filter 230y may range from about 0.1 μm to about 1 μm.

According to the exemplary embodiment, a ratio “green:yellow” of the thickness of the green color filter 230G to the thickness of the yellow color filter 230y may be about 99:1 to about 50:50. As an example, when the yellow color filter 230y is formed on the green color filter 230G with both the yellow and green color filters 230y and 230G having the same thickness, the ratio “green:yellow” would be 50:50.

Furthermore, in some embodiments, a ratio “red:yellow” of the thickness of the red color filter 230R to the thickness of the yellow color filter 230y may be about 99:1 to about 70:30.

According to the exemplary embodiment of FIG. 1, the yellow color filter 230y layer may be formed on the green color filter 230G and/or the red color filter 230R so as to improve color reproducibility.

FIG. 2 is a cross-sectional view of a liquid crystal display according to the comparative example. Specifically, FIG. 2 is a cross-sectional view of an upper substrate 210 and a color filter 230′ of the liquid crystal display according to the comparative example. The color filter 230′ is formed in each pixel. For example, a blue color filter 230B is formed in a first pixel, a green color filter 230G is formed in a second pixel, and a red color filter 230R is formed in a third pixel. The blue, green and red color filters 230B, 230G, and 230R are formed adjacent to each other.

However, unlike the embodiment of FIG. 1, a separate yellow color filter (e.g., 230y) is not formed on the blue, red, and green color filters 230B, 230R, and 230G in the comparative example of FIG. 2.

In the liquid crystal display according to the comparative example, a thickness of each color filter is controlled to change a color coordinate. When the color coordinates are changed by controlling the thickness of the color filter, a main coordinate (Y) of each color is changed. However, sub-coordinates (x, y) of the color is not changed.

Table 1 below illustrates the change in the main coordinates and the sub-coordinates depending on the change in thickness of each color filter in the liquid crystal display according to the comparative example. RY, GY, and BY correspond to the main coordinates of the red, green, and blue colors, respectively; and (Rx, Ry), (Gx, Gy), and (Bx, By) correspond to the sub-coordinates of the red, green, and blue colors, respectively.

TABLE 1

| | | Thickness of color filter | | |
|---|---|---|---|---|
| | Color filter | 2.0 um | 2.25 um | 2.5 um |
| Mai [symbol] | RY | 16.9 | 17.8 | 17.6 |
| | Rx | 0.666 | 0.649 | 0.657 |
| | Ry | 0.320 | 0.320 | 0.319 |
| | GY | 57.8 | 54.1 | 56.6 |
| | Gx | 0.259 | 0.256 | 0.257 |
| | Gy | 0.575 | 0.579 | 0.586 |
| | BY | 9.9 | 8.3 | 9.4 |
| | Bx | 0.137 | 0.140 | 0.137 |
| | By | 0.093 | 0.084 | 0.090 |

[symbol]

indicates data missing or illegible when filed

As shown in Table 1, when the thickness of the red color filter is increased, the main coordinate RY of the red color changes. However, the sub-coordinates Rx and Ry of the red color do not change substantially.

Likewise, when the thickness of the green color filter is increased, the main coordinate GY of the green color changes. However, the sub-coordinates Gx and Gy of the green color do not change substantially.

Furthermore, when the thickness of the blue color filter is increased, the main coordinate BY of the blue color changes. However, the sub-coordinates Bx and By of the blue color do not change substantially.

Therefore, in the liquid crystal display according to the comparative example, the sub-coordinates of the colors do not change substantially when the thickness of the color filters is increased. As a result, color reproducibility is reduced, and the color gamut that can be displayed is limited in the comparative example.

However, in the liquid crystal display according to the exemplary embodiment, the yellow color filter may be formed on the red color filter and/or the green color filter, which can substantially change the main coordinates and sub-coordinates of the colors. Accordingly, in the liquid crystal display according to the exemplary embodiment, color reproducibility may be improved, and the color gamut that can be displayed is increased.

Furthermore, by forming the yellow color filter on the green color filter and/or the red color filter, a yellow pigment may be omitted from the green color filter and/or the red color filter. Accordingly, a manufacturing process for the color filters may be simplified in the exemplary embodiment.

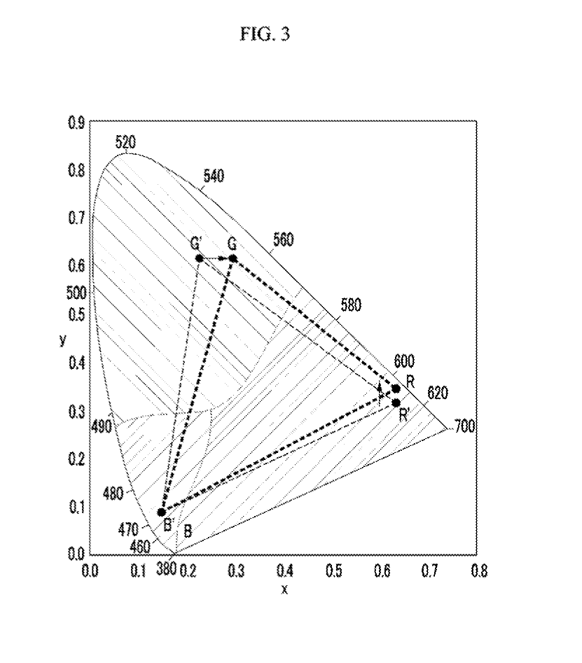

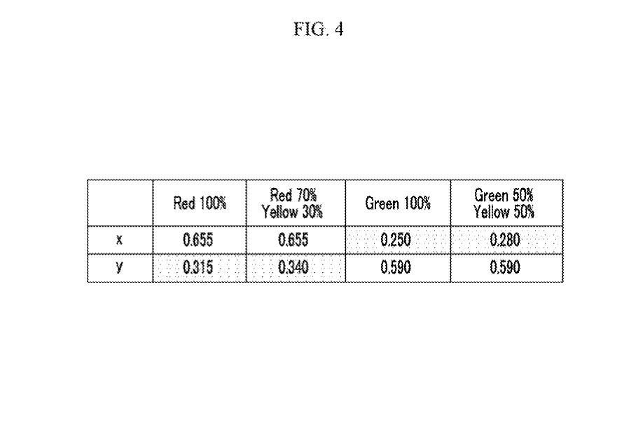

FIG. 3 is a diagram illustrating a shift in color coordinates between the liquid crystal display according to the exemplary embodiment of FIG. 1 and the liquid crystal display according to the comparative example of FIG. 2. FIG. 4 is a table containing values of the color coordinate shift in FIG. 3.

Referring to FIG. 3, the R′, G′, and B′ points indicate color coordinates of the liquid crystal display according to the comparative example in which the yellow color filter is not formed. The R, G, and B points indicate color coordinates of the liquid crystal display according to the exemplary embodiment in which the yellow color filter is formed on the red color filter and/or the green color filter.

Referring to FIGS. 3 and 4, when only the green color filter (100% green) is formed, a color coordinate G′ has an x coordinate of 0.250 and a y coordinate of 0.590. However, when the yellow color filter is formed on the green color filter at a ratio of 50:50 (50% green and 50% yellow), the color coordinate G has an x coordinate of 0.280 and a y coordinate of 0.590. That is, it may be observed that the x coordinate (a sub-coordinate of the green color) may increase from 0.250 to 0.280 (a difference of 0.030) when the yellow color filter is formed on the green color filter at the ratio of 50:50. As shown in FIG. 3, the sub-coordinate of the green color moves in a direction from left to right (G′→G), and a color that cannot be displayed conventionally in the comparative example may thus be displayed in the exemplary embodiment.

Referring again to FIGS. 3 and 4, when only the red color filter (100% red) is formed, a color coordinate R′ has an x coordinate of 0.655 and a y coordinate of 0.315. However, when the yellow color filter is formed on the red color filter at a ratio of 70:30 (70% red and 30% yellow), the color coordinate R has an x coordinate of 0.655 and a y coordinate of 0.340. That is, it may be observed that the y coordinate (a sub-coordinate of the red color) may increase from 0.315 to 0.340 (a difference of 0.025) when the yellow color filter is formed on the red color filter at the ratio of 70:30. As shown in FIG. 3, the sub-coordinate of the red color moves in an upward direction (R′→R), and a color that cannot be displayed conventionally in the comparative example may thus be displayed in the exemplary embodiment.

Referring to FIG. 3, in the display device according to the exemplary embodiment, the R and G sub-coordinates can be changed by the formation of the yellow color filter, such that an area of a triangle connecting the R, G, and B coordinates may be increased. As shown in FIG. 3, the triangle area formed by the R, G, and B coordinates is larger than the triangle area formed by the R′, G′, and B′ coordinates. The color reproducibility is associated with the size of the triangle area, and increases as the triangle area increases. Accordingly, color reproducibility is improved in the exemplary embodiment compared to the comparative example.

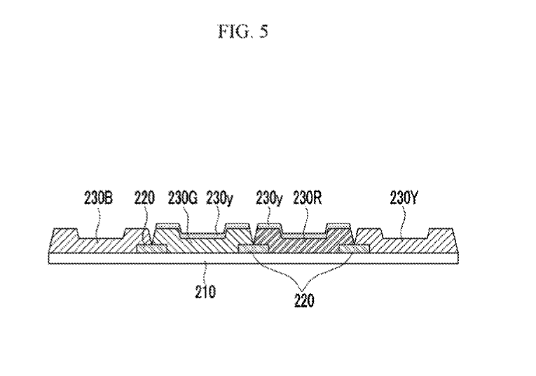

FIG. 5 is a cross-sectional view of a liquid crystal display according to another exemplary embodiment. The embodiment of FIG. 5 includes elements similar to those in the embodiment of FIG. 1. As such, a detailed description of those similar elements will be omitted. The embodiment of FIG. 5 differs from the embodiment of FIG. 1 as follows.

In the exemplary embodiment of FIG. 5, the color filter 230 includes four types of color filters formed in each pixel, instead of three types. The color filter 230 is formed in each pixel. For example, a blue color filter 230B is formed in a first pixel, a green color filter 230G is formed in a second pixel, a red color filter 230R is formed in a third pixel, and a yellow color filter 230Y is formed in a fourth pixel. The blue, green red, and yellow color filters 230B, 230G, 230R, and 230Y are formed adjacent to each other. Similar to the embodiment of FIG. 1, a yellow color filter 230y is formed on the red color filter 230R and the green color filter 230G in the embodiment of FIG. 5.

In some embodiments (not illustrated), the yellow color filter 230Y may be replaced by a white color filter 230W on which a a yellow color filter 230y is formed.

Accordingly, a larger color gamut may be provided and power consumption may be reduced using the above embodiments. Furthermore, when the display device includes the four colors red, green, blue, and white, the formation of the yellow color filter on the white color filter can mitigate a bluish problem, whereby a screen appears to be of a deeper blue than is intended.

Next, a structure of the liquid crystal display including the color filter will be described. It should be noted that the structure of the color filter according to the exemplary embodiment may be applied to a liquid crystal display having other types of pixel structure.

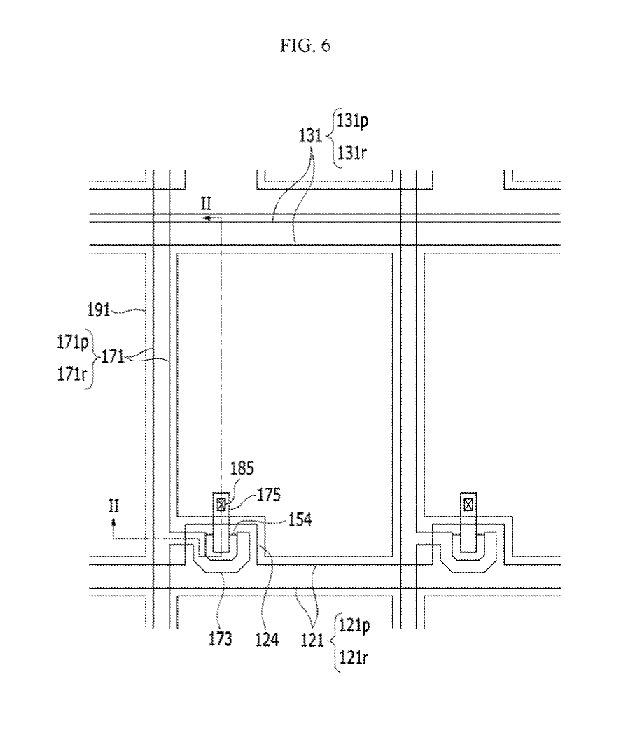

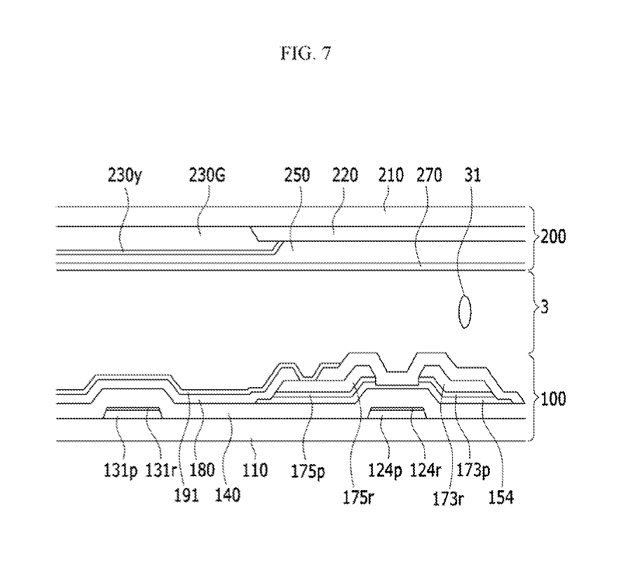

FIG. 6 is a layout view of a liquid crystal display according to an exemplary embodiment. FIG. 7 is a cross-sectional view of the liquid crystal display of FIG. 6 taken along line II-II.

First, a lower display panel 100 will be described. The lower display panel 100 includes a plurality of gate lines 121 formed on a lower substrate 110. The lower substrate 110 may be an insulating substrate made of transparent glass, plastic, or the like.

The gate lines 121 transfer gate signals and extend in a substantially horizontal direction. The gate lines 121 include a plurality of gate electrodes 124 protruding from the gate lines 121.

The gate lines 121 and the gate electrodes 124 may have a double layer structure comprising a first layer 121p and a second layer 121r. Each of the first layer 121p and the second layer 121r may be made of aluminum-based metals (such as aluminum (Al) or an aluminum alloy), silver-based metals (such as silver (Ag) or a silver alloy), copper-based metals (such as copper (Cu) or a copper alloy), molybdenum-based metals (such as molybdenum (Mo) or a molybdenum alloy), chromium (Cr), titanium (Ti), tantalum (Ta), manganese (Mn), and the like. For example, in some embodiments, the first layer 121p may include titanium, and the second layer 121r may include copper or a copper alloy.

Further, the first layer 121p and the second layer 121r may be formed by combining layers having different physical properties. In the exemplary embodiment of FIGS. 6 and 7, the gate line 121 and gate electrode 124 are formed having a double layer structure. However, the inventive concept is not limited thereto. In some other embodiments, the gate line 121 and the gate electrode 124 may be formed as a single layer or having a triple layer structure.

A storage electrode line 131 is positioned parallel with the gate lines 121. The storage electrode line 131 may be formed parallel with the gate lines 121 while crossing the pixel area. The storage electrode line 131 may also have a double layer structure comprising a first layer 131p and a second layer 131r.

Each of the first layer 131p and the second layer 131r may be made of aluminum-based metals (such as aluminum (Al) or an aluminum alloy), silver-based metals (such as silver (Ag) or a silver alloy), copper-based metals (such as copper (Cu) or a copper alloy), molybdenum-based metals (such as molybdenum (Mo) or a molybdenum alloy), chromium (Cr), titanium (Ti), tantalum (Ta), manganese (Mn), and the like. For example, in some embodiments, the first layer 131p may include titanium, and the second layer 131r may include copper or a copper alloy.

The storage electrode line 131 may be formed by the same process as the gate line 121. Also, the material and structure of the storage electrode line 131 and the gate line 121 may be the same.

A gate insulating layer 140 is positioned on the gate line 121 and the storage electrode line 131. The gate insulating layer 140 may be made of an insulating material such as silicon oxide, silicon nitride, or the like. In some embodiments, the gate insulating layer 140 may have a multi-layer structure including at least two insulating layers having different physical properties.

A plurality of semiconductor layers 154 are formed on the gate insulating layer 140. The semiconductor layers 154 may be made of a semiconductor oxide. The semiconductor layers 154 may include at least one of zinc (Zn), indium (In), tin (Sn), gallium (Ga), and hafnium (Hf). The semiconductor layers 154 extend in a substantially vertical direction and include a plurality of projections extending toward the gate electrode 124.

A plurality of data lines 171, source electrodes 173, and drain electrodes 175 are formed on the semiconductor layers 154 and the gate insulating layer 140. The source electrodes 173 and the drain electrodes 175 are connected to the data lines 171.

The data lines 171 transfer data signals and extend in a substantially vertical direction to intersect the gate lines 121. Each source electrode 173 extends from the data line 171 overlapping the gate electrode 124, and may be substantially formed in the shape of a letter “U”. The drain electrode 175 is separated from the data line 171 and extends upward from a center of the U-shaped source electrode 173.

Each of the data lines 171, source electrodes 173, and drain electrodes 175 has a double layer structure comprising lower barrier layers 171p, 173p, and 175p and main wiring layers 171r, 173r, and 175r. The lower barrier layers 171p, 173p, and 175p are made of metal oxide. The main wiring layers 171r, 173r, and 175r are made of copper or a copper alloy. In some embodiments, the lower barrier layers 171p, 173p, and 175p may be made of one of the following materials: indium-zinc oxide, gallium-zinc oxide, and aluminum-zinc oxide. The lower barrier layers 171p, 173p, and 175p serve as a diffusion-inhibiting layer to prevent materials such as copper from diffusing into the semiconductor layer 154.

A passivation layer 180 is formed on the main wiring layers 171r, 173r, and 175r. The passivation layer 180 may be made of inorganic insulating materials (such as silicon nitride or silicon oxide), organic insulating materials, low-K insulating materials, and the like.

A plurality of contact holes 185 are formed through the passivation layer 180 so as to expose one end of the drain electrodes 175.

The passivation layer 180 may be formed having a double layer structure including a lower passivation layer and an upper passivation layer. The lower passivation layer may be made of silicon oxide and the upper passivation layer may be made of silicon nitride. In the exemplary embodiment, since the semiconductor layer 154 includes a semiconductor oxide, the lower passivation layer that is adjacent to the semiconductor layer 154 may also be made of a semiconductor oxide, e.g., silicon oxide. It is noted that when the lower passivation layer is made of silicon nitride, some characteristics of the thin film transistor may be less optimal.

The plurality of pixel electrodes 191 are formed on the passivation layer 180. Each pixel electrode 191 is physically and electrically connected to the drain electrode 175 through the contact hole 185. A data voltage is applied to the pixel electrode 191 from the drain electrode 175. The pixel electrodes 191 may be made of transparent conductive materials such as ITO or IZO.

Next, an upper display panel 200 will be described. Referring to FIGS. 6 and 7, an upper substrate 210 is disposed facing the lower substrate 110. The upper substrate 210 may be an insulating substrate made of transparent glass, plastic, or the like. A light blocking member 220 is formed on the upper substrate 210. The light blocking member 220 is referred to as a black matrix and prevents light leakage.

A plurality of color filters 230 are formed on the upper substrate 210 and the light blocking member 220. The color filters 230 are disposed in the region enclosed by the light blocking member 220. The color filters 230 may extend vertically along a column direction of the pixel electrode 191.

The color filters 230 may include the exemplary color filters previously described in FIGS. 1 and 5. That is, each color filter 230 may display one of primary colors such as the three primary colors red, green, and blue. A yellow color filter layer may be positioned on the red color filter and the green color filter.

FIG. 7 illustrates a configuration in which the yellow color filter 230y layer is formed on the green color filter 230G. However, the inventive concept is not limited thereto. In some embodiments, the yellow color filter 230y may be formed on both the green color filter 230G and the red color filter 230R. In some other embodiments, the yellow color filter 230y may be formed on only one of the green color filter 230G and the red color filter 230R.

The sub-coordinates of the green and/or red color may be controlled by forming the yellow color filter on the green color filter and/or the red color filter. Accordingly, colors that cannot be displayed using conventional display devices may be easily displayed using the exemplary display device. Also, the triangle area connecting the R, G, and B coordinates is greater in the exemplary display device compared to that of a conventional display device. Accordingly, color reproducibility is improved in the exemplary display device.

In the above-described embodiments, the light blocking member 220 and the color filter 230 are formed on the upper display panel 200. However, the inventive concept is not limited thereto. In some other embodiments, at least one of the light blocking member 220 and the color filter 230 may also be formed on lower display panel 100.

An overcoat 250 is formed on the color filter 230 and the light blocking member 220. The overcoat 250 may be made of an insulating material. The overcoat 250 protects the color filter 230 and provides a flat surface. In some alternative embodiments, the overcoat 250 may be omitted.

A common electrode 270 is formed on the overcoat 250.

A data voltage is applied to the pixel electrode 191 and a common voltage is applied to the common electrode 270, so as to generate an electric field. The electric field determines an alignment of liquid crystal molecules 31 of the liquid crystal layer 3 between the two electrodes (pixel electrode 191 and common electrode 270). The pixel electrode 191 and the common electrode 270 collectively constitute a capacitor that can maintain an applied voltage even after the thin film transistor is turned off.

The pixel electrode 191 may overlap the storage electrode line 131 so as to form a storage capacitor, and thus the voltage maintaining capability of the liquid crystal capacitor may be further improved.

According to one or more of the above embodiments of the liquid crystal display, the color filter is not formed as a single layer. Instead, a yellow color filter layer is formed on a green color filter and/or a red color filter, thereby enabling colors that cannot be displayed conventionally to be easily displayed. In addition, color reproducibility can improved using one or more of the above embodiments.

While the inventive concept has been described in connection with what is presently considered to be exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a first substrate, wherein a plurality of thin film transistors and a plurality of pixel electrodes connected thereto are formed on the first substrate; and
a second substrate facing the first substrate and including a color filter,
wherein the color filter includes a blue color filter, a green color filter, and a red color filter corresponding to each pixel electrode, and
a yellow color filter is formed on at least one of the green color filter and the red color filter.

2. The liquid crystal display of claim 1, wherein a thickness of the green color filter ranges from about 1 μm to about 2 μm.

3. The liquid crystal display of claim 1, wherein a thickness of the red color filter ranges from about 1 μm to about 2 μm.

4. The liquid crystal display of claim 2, wherein the yellow color filter is formed on the green color filter, and a ratio of a thickness of the green color filter to a thickness of the yellow color filter is between about 99:1 to about 50:50.

5. The liquid crystal display of claim 2, wherein the yellow color filter is formed on the red color filter, and a ratio of a thickness of the red color filter to a thickness of the yellow color filter is between about 99:1 to about 70:30.

6. The liquid crystal display of claim 1, wherein a thickness of the yellow color filter ranges from about 0.1 μm to about 1 μm.

7. The liquid crystal display of claim 1, wherein the color filter further includes a white color filter corresponding to each pixel electrode.

8. The liquid crystal display of claim 7, wherein the yellow color filter is formed on the white color filter.

9. The liquid crystal display of claim 1, wherein the color filter further includes a white color filter and a second yellow color filter corresponding to each pixel electrode.

10. The liquid crystal display of claim 1, wherein a yellow pigment is omitted from the green color filter.

11. The liquid crystal display of claim 1, wherein a yellow pigment is omitted from the red color filter.

12. The liquid crystal display of claim 1, wherein a common electrode is formed on the second substrate.

13. The liquid crystal display of claim 2, wherein a black matrix is formed between the blue color filter, the green color filter, and the red color filter.
